(19) United States
(12) Patent Application Publication
(10) Pub. No.: US 2007/0067669 A1
(43) Pub. Date: Mar. 22, 2007

(54) METHOD OF IDENTIFYING A FAILING STORAGE DEVICE BASED ON COMMON FACTOR OBJECT INCONSISTENCY

(76) Inventors: John Mark Morris, San Diego, CA (US); Paul Andersen, San Diego, CA (US); Gary Boggs, San Diego, CA (US); Criselda Carrillo, San Diego, CA (US); John Catozzi, San Diego, CA (US); Peter Frazier, Princeton, NJ (US)

Correspondence Address: Intellectual Property Section;Law Department, NCR Corporation, 1700 South Patterson Blvd., Dayton, OH, 45479-0001, US

(21) Appl. No.: 11/530,144

(22) Filed: Sep. 8, 2006

Related U.S. Application Data
(60) Provisional application No. 60/719,490, filed on Sep. 22, 2005.

(51) Int. Cl. G06F 11/00

(52) U.S. Cl. 714/6

(57) ABSTRACT

A technique for use in identifying a failing storage device from a plurality of such storage devices involves the use of an inconsistency map. This inconsistency map is maintained by selecting one or more protected objects and identifying the storage devices on which the protected objects are stored. Copies of the protected objects on the identified storage devices are compared. On detecting a mismatch between copies of one of the protected objects, details are stored in an inconsistency map of the mismatched protected object and details of the storage devices on which the mismatched protected object is stored.

### CROSS-REFERENCE TO RELATED APPLICATION

This application claims benefit of U.S. Provisional Application 60/719,490, filed on Sep. 20, 2005.

### BACKGROUND

Computer systems are often subject to data-corruption during storage to disk (or some other storage device) and during transmission between computers or devices within a computer. Such data corruption is one cause of a condition known as data inconsistency. It is not uncommon for data inconsistency to arise in storage systems that provide data protection via redundancy.

A data inconsistency occurs when redundant representations of the same information do not match. Examples of this inconsistency include a situation where a primary and secondary mirror does not match or a stored random access integrated device (RAID-5) parity does not match the calculated parity from the other devices. In addition to data corruption, inconsistency can be caused by an incomplete write of a data object to some but not all devices or sectors and could also be caused by intermittent error.

When inconsistencies exist, there is a need to identify the root cause of the inconsistency. In some cases the root cause is a single failing device and it is necessary to identify that single failing device. A storage device identified as failing can then be marked out of service and subsequent reads of objects on that failed device can proceed by recovering the correct data from the remaining redundant data on other non-failing devices. Without knowledge of the probable failing device, it is impossible to correctly recover the data.

### SUMMARY

Described below is a method of identifying a failing storage device from a plurality of such storage devices. Protected objects are stored on the storage devices. These data objects are protected by storing redundant copies of the data object on at least one other storage device within the plurality of storage devices. This plurality of storage devices is known as a redundancy group.

In one technique, an inconsistency map is maintained. This inconsistency map is maintained by selecting one or more protected objects and identifying the storage devices on which the protected objects are stored. Copies of the protected objects on the identified storage devices are compared. On detecting a mismatch between copies of one of the protected objects, details are stored in an inconsistency map of the mismatched protected object and details of the storage devices on which the mismatched protected object is stored.

From the inconsistency map is identified the storage devices on which mismatched protected objects are stored. The technique then concludes that at least one of the identified storage devices is failing.

The step of identifying the storage devices in one form of the technique further comprises creating a plurality of counter variables, each associated with respective storage devices, setting each counter variable to zero. For each mismatched object in the inconsistency map, the storage devices are determined on which the mismatched object is stored and the counter variable(s) associated with the determined storage device(s) are incremented.

Also described below are related techniques of identifying a failing storage device in the form of a system for identifying such failing storage devices and computer programs stored on tangible storage media for identifying such failing storage devices.

### BRIEF DESCRIPTION OF THE DRAWINGS

FIG. 1 is a block diagram of a computer system with failing device identification capability.

FIG. 2 is a detailed diagram of the system of FIG. 1 showing sample data.

FIG. 3 is a flow chart of a technique for calculating the likelihood of a failing device.

FIG. 4 is a block diagram of a large computer system having failing device identification capability.

### DETAILED DESCRIPTION

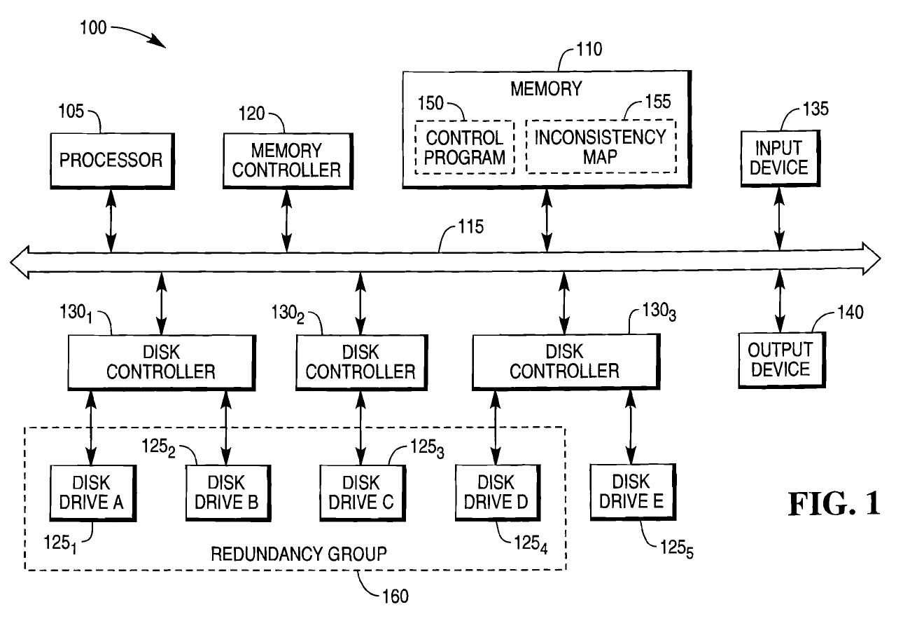

FIG. 1 shows a computer system 100 that detects and corrects errors occurring in stored data. The system 100 includes one or more processors 105 that receive data and program instructions from a temporary data storage device such as a memory device 110 over a communications bus 115. A memory controller 120 governs the flow of data into and out of the memory device 110. The system 100 also includes one or more persistent data storage devices such as disk drives 125_{1 . . . 5}, labeled A, B, C, D and E respectively, that store chunks of data in a manner prescribed by one or more disk controllers 130, for example 130₁, 130₂ and 130₃. One or more input devices 135 such as a mouse and a keyboard and output devices 140 such as a monitor and a printer allow the computer system to interact with a human user and with other computers.

The system also includes a control program 150 that typically resides on one of the disk drives and is then loaded into memory at run time. Like control programs in conventional computer systems, the control program 150 here contains instructions or program code that, when executed by the processor, allow the computer system to carry out operations on the data stored on the disk drives. Unlike other control programs, this program includes code that allows the computer to assess the likelihood of a particular disk drive, for example one of disk drives A to E, as being a failing disk drive. The control program 150 has access to an inconsistency map 155. The inconsistency map maintains details of protected data objects stored over two or more of disk drives A to E for which there are inconsistencies between the copies of the protected object stored on the different disk drives. Disk drives A to D form a redundancy group 160.

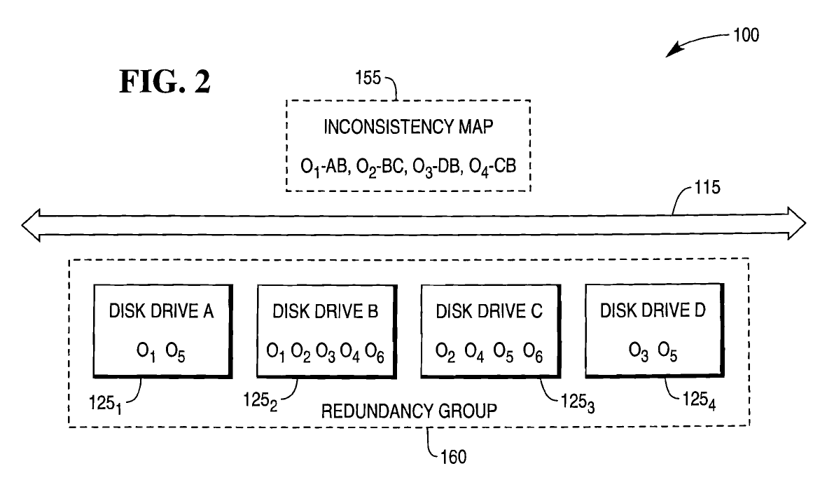

FIG. 2 shows several data objects stored in disk drives A to D. In practice, there will be many data objects but for the purposes of explanation only six data objects are shown. Data object O₁ for example is stored on disk drive A. Disk drive A is where reads and writes take place to access, update and modify object O₁. A redundant copy of object O₁ is also stored on disk drive B. Each time object O₁ on disk drive A is modified, the same object is also written to disk drive B.

Similarly, object O₂ is stored on disk drive B with a redundant copy on disk drive C. Object O₃ is stored on disk drive D with a redundant copy on disk drive B. Object O₄ is stored on disk drive C with a redundant copy on disk drive B. Object O₅ is stored on disk drive A with redundant copies on disk drives C and D. Object O₆ is stored on disk drive C with a redundant copy on disk drive B.

As shown in FIG. 2 there is some data inconsistency in this example involving objects O₁, O₂, O₃ and O₄. Inconsistency map 155 identifies objects O₁ to O₄ as having data inconsistencies between the devices on which copies of these data objects are stored. The devices to which the data objects are mapped are indicated in the inconsistency map.

As will be described below, the technique here is to scan the inconsistency map 155 and analyze the pattern of devices in the redundancy group 160 mapping to inconsistent objects O₁ to O₄. This analysis then yields data that can be used to predict the likely failing device if one exists.

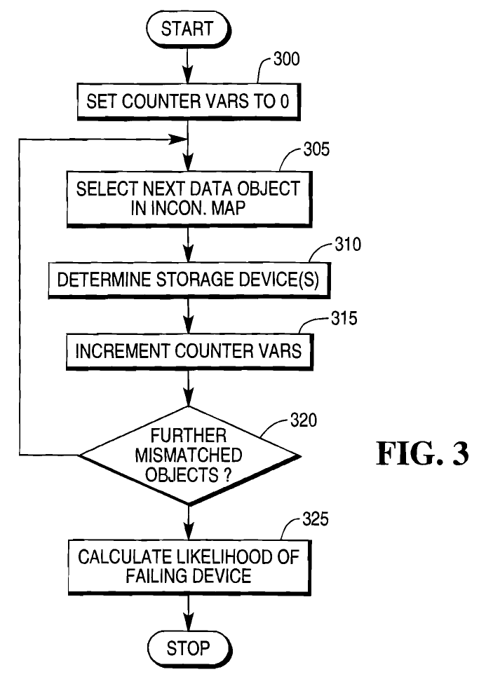

FIG. 3 shows one example of a technique that is used to count the number of inconsistent objects per storage device. Each of disk drives A to D has an associated counter variable that is created for each device in redundancy group 160. Each counter variable is set or initialized to zero (step 300).

Each protected object listed in the inconsistency map is then analyzed. To do this the first mismatched data object is first selected from the inconsistency map (step 305). This will be data object O₁ as shown in FIG. 2.

Having selected the data object, the technique then determines the storage device or storage devices on which the mismatched data object is stored (step 310). For the first data object O₁, the storage devices will be disk drive A and disk drive B.

The counter variables associated with disk drive A and disk drive B are then incremented (step 315) to record the fact that both disk drives A and disk drive B are possible causes of a data inconsistency.

Subsequent data objects are then examined (step 320).

After the method has been executed for the situation set out in FIG. 2, the counter variable for disk drive A will have the value 1, the counter variable for disk drive B will have the value 4, the counter variable for disk drive C will have the value 2 and the counter variable for disk drive D will have the value 1. This can be set out in Table 1 below:

TABLE 1

| Disk Drive | Inconsistent Objects |
|---|---|
| A | 1 |
| B | 4 |
| C | 2 |
| D | 1 |

The technique then calculates the likelihood of one of the devices being a failing device (step 325). In the situation set out in FIG. 2 above, disk drive B was involved in all four inconsistent data objects O₁ to O₄ and is therefore likely to be the failing device.

In other circumstances the analysis will find that no single device is able to explain all object inconsistencies. In these circumstances the technique examines pairs of disk drive devices. For each distinct pair of disk drives, if one of the disk drives from the pair has stored on it a mismatched protected object, then the counter variable associated with that pair of disk drives is incremented to record the fact that that pair of disk drives is the possible cause of a data inconsistency. The results of this count for the situation set out in FIG. 2 above are set out below in Table 2:

TABLE 2

| Disk Drive Pair | Inconsistent Objects |
|---|---|
| AB | 5 |
| AC | 3 |
| AD | 2 |
| BC | 6 |
| BD | 5 |
| CD | 3 |

As will be apparent, the first disk drive pair AB has the counter variable 5 indicating the number of mismatched protected objects associated with either disk drive A or disk drive B.

In one form of the technique, only some of the disk drive pairs are considered. These are the disk drive pairs having counter variable values greater than or equal to the number of objects in the inconsistency map. In Table 2 above, the pairs that would be selected for further analysis would be disk drive pairs AB, BC and BD. There are 4 data objects in the inconsistency map and so the above three pairs are selected as they each have a counter variable value greater than or equal to 4.

In circumstances where it is not clear from an analysis of single disk drives or pairs of disk drives, the technique then considers triplets of disk drives, quadruplets and so on.

In other circumstances an analysis of singles, pairs, triples, quadruples or higher cannot clearly identify failing devices and so well known statistical methods are used to identify outlier devices and to calculate the probability or confidence interval on the likelihood of any given device being a failing device.

Object inconsistencies represented in the inconsistency map are symptoms of some set of disk failures. A set of disk failures is referred to as a “failure scenario”. There are many failure scenarios that can explain a particular object inconsistency, but the analysis method preferably chooses the most likely one. To calculate the probability that a chosen failure scenario is correct, the likelihood of the chosen scenario occurring is divided by the sum of the likelihoods of all possible failure scenarios.

The first step in the situation described above in FIG. 2 is to calculate the probability or confidence that disk drive device B has failed. The object inconsistencies can be explained by a failing device B but the object consistencies can also be explained by the failures of disk drive devices A, C and D. Scenario B for example represents a scenario in which disk drive B is one of the disk drives that fails. Scenario B therefore includes the disk failures B, AB, BC, BD, ABC, BCD, ABD and ABCD. Scenario ACD for example includes disk failures ACD and ABCD.

Strictly speaking, the inclusion of ABCD in both scenarios B and ACD means that the probability of ABCD occurring should be subtracted from the denominator when summing the probability of scenario B and the probability of scenario ACD so that the scenario ABCD is only counted once. However this is not so important in practice as the probability of scenario ABCD is a low probability occurrence.

It is assumed that the probability of a disk failure is some constant for example p. A typical value for p is 10⁻⁵. The probability of scenario B involves the failure of one disk and so the probability of scenario B is p. Scenario ACD involves the failure of at least three disk drives and so the probability is p³. In general the probability of a scenario in which n disks fail is pⁿ. The probability that scenario B is the correct scenario given the object consistencies observed above is:

$$P ( B ) = \frac{p}{p + {p}^{3}} = \frac{1}{1 + {p}^{2}}$$

If p equals 10⁻⁵ as is the case for some installations, there is a 99.99999999% confidence or probability that scenario B is the correct scenario.

One method of calculating a value to assign to p is to review failure reports from the field. For example if a particular company observes 20 corruptions in the previous year there are 4,000 disk drives involved, and a data cleansing or scrubbing is routinely performed once a week, the probability p that any given disk drive fails in any given week is:

$$P ( fail ) = 20 \frac{1}{52} \frac{1}{4 \text{,} 000} {\approx }^{{10}^{- 5}}$$

Devices that can be confidently identified as failing are marked out of service. Subsequent reads of the object can proceed by recovering the correct data from the remaining redundant data.

It will be appreciated that this technique works best in cases other than when every protected object is mapped to all devices in the redundancy group. For example, if all of objects O₁ to O₆ were each stored on each of disk drives A to D, it would not be possible to use inconsistency information to identify one of the disk drives as being a failing device.

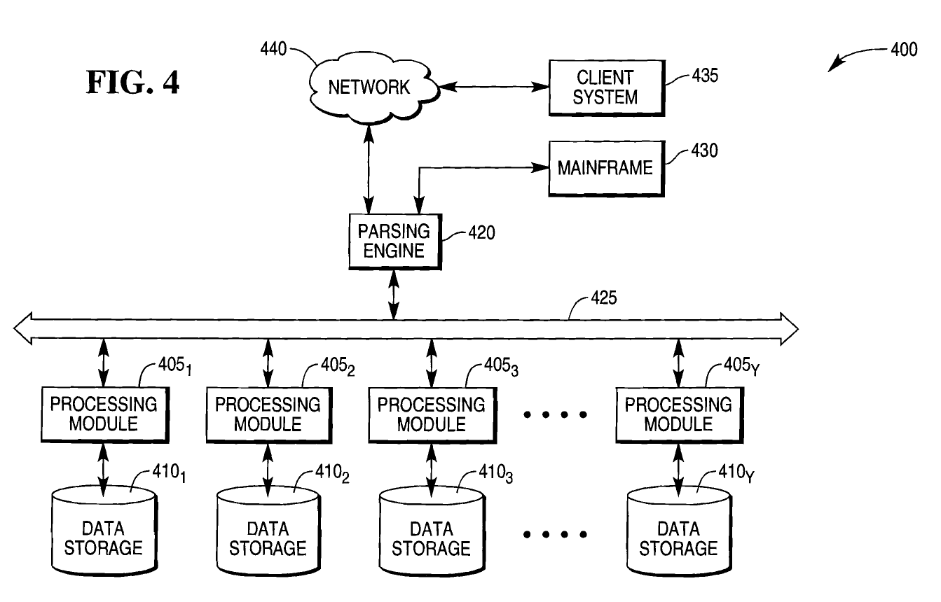

FIG. 4 shows an example of one type of computer system in which the above techniques of identifying a failing storage device are implemented. The computer system is a data warehousing system 400, such as a TERADATA data warehousing system sold by NCR Corporation, in which vast amounts of data are stored on many disk storage facilities that are managed by many processing units. In this example, the data warehouse 400 includes a relational database management system (RDBMS) built upon a massively parallel processing (MPP) platform. Other types of database systems, such as object-relational database managements (ORDMS) or those built on symmetric multi-processing (SMP) platforms are also suited for use here.

As shown, the data warehouse 400 includes one or more processing modules 405_{1 . . . y} that manage the storage and retrieval of data in data storage facilities 410_{1 . . . y}. Each of the processing modules 405_{1 . . . y} manages a portion of the database that is stored in a corresponding one of the data storage facilities 410_{1 . . . y}. Each of the data storage facilities 410_{1 . . . y} includes one or more disk drives.

A parsing engine 420 organises the storage of data and the distribution of data objects stored in the disk drives among the processing modules 405_{1 . . . y}. The parsing engine 420 also coordinates the retrieval of data from the data storage facilities 410_{1 . . . y} over communications bus 425 in response to queries received from a user at a mainframe 430 or a client computer 435 through a wired or wireless network 440.

The text above describes one or more specific embodiments of a broader invention. The invention also is carried out in a variety of alternative embodiments and thus is not limited to those described here. Those other embodiments are also within the scope of the following claims.

We claim:

1. A method of identifying a failing storage device from a plurality of storage devices, in which at least one of the data objects stored on one of the storage devices is a protected object stored on at least one other storage device within the plurality of storage devices, the method comprising:
selecting one or more protected objects;
identifying the storage devices on which the protected objects are stored;
comparing the copies of the protected objects on the identified storage devices;
on detecting a mismatch between copies of one of the protected objects, storing in an inconsistency map details of the mismatched protected object and details of the storage devices on which the mismatched protected object is stored;
identifying from the inconsistency map the storage devices on which mismatched protected objects are stored; and
concluding that at least one of the identified storage devices is failing.

2. The method of claim 1 wherein the step of identifying the storage devices further comprises:
creating a plurality of counter variables, each associated with respective storage devices;
setting each counter variable to zero;
for each mismatched object in the inconsistency map, determining the storage devices on which the mismatched object is stored and incrementing the counter variable(s) associated with the determined storage device(s).

3. The method of claim 2 further comprising calculating the likelihood of any one or more of the identified storage devices being a failing storage device from the counter variables.

4. The method of claim 1 further comprising selecting all protected objects for detecting mismatches.

5. The method of claim 4 wherein the steps of selecting all protected objects, comparing the protected objects, and storing details on detecting a mismatch are performed periodically.

6. The method of claim 4 wherein the steps of selecting all protected objects, comparing the protected objects, and storing details on detecting a mismatch are performed continuously.

7. The method of claim 1 wherein the step of identifying the storage devices further comprises:
creating a plurality of counter variables, each associated with respective pairs of storage devices;
setting each counter variable to zero;
for each mismatched object in the inconsistency map, determining the storage devices on which the mismatched object is stored and incrementing the counter variable(s) associated with the determined pair of storage devices.

8. The method of claim 1 further comprising:
maintaining a list of modified protected objects; and
following a system failure, selecting one or more protected objects from the list of modified protected objects.

9. A method of identifying a failing storage device from a plurality of storage devices in which at least one of the data objects stored on one of the storage devices is a protected object stored on at least one other storage device within the plurality of storage devices, and in which an inconsistency map is maintained of protected objects for which there is a mismatch between copies of the protected object stored on different storage devices, the method comprising:
identifying from the inconsistency map the storage devices on which mismatched protected objects are stored; and
concluding that at least one of the identified storage devices is failing.

10. The method of claim 9 wherein the step of identifying the storage devices further comprises:
creating a plurality of counter variables, each associated with respective storage devices;
setting each counter variable to zero;
for each mismatched object in the inconsistency map, determining the storage devices on which the mismatched object is stored and incrementing the counter variable(s) associated with the determined storage device(s).

11. The method of claim 10 further comprising calculating the likelihood of any one or more of the identified storage devices being a failing storage device from the counter variables.

12. A system for identifying a failing storage device from a plurality of storage devices, in which at least one of the data objects stored on one of the storage devices is a protected object stored on at least one other storage device within the plurality of storage devices, where the system is configured to:
select one or more protected objects;
identify the storage devices on which the protected objects are stored;
compare the copies of the protected objects on the identified storage devices;
on detecting a mismatch between copies of one of the protected objects, store in an inconsistency map details of the mismatched protected object and details of the storage devices on which the mismatched protected object is stored;
identify from the inconsistency map the storage devices on which mismatched protected objects are stored; and
conclude that at least one of the identified storage devices is failing.

13. A system for identifying a failing storage device from a plurality of storage devices in which at least one of the data objects stored on one of the storage devices is a protected object stored on at least one other storage device within the plurality of storage devices, and in which an inconsistency map is maintained of protected objects for which there is a mismatch between copies of the protected object stored on different storage devices, where the system is configured to:
identify from the inconsistency map the storage devices on which mismatched protected objects are stored; and
conclude that at least one of the identified storage devices is failing.

14. A computer program stored on tangible storage media comprising executable instructions for performing a method of identifying a failing storage device from a plurality of storage devices, in which at least one of the data objects stored on one of the storage devices is a protected object stored on at least one other storage device within the plurality of storage devices, the method comprising:
selecting one or more protected objects;
identifying the storage devices on which the protected objects are stored;
comparing the copies of the protected objects on the identified storage devices;
on detecting a mismatch between copies of one of the protected objects, storing in an inconsistency map details of the mismatched protected object and details of the storage devices on which the mismatched protected object is stored;
identifying from the inconsistency map the storage devices on which mismatched protected objects are stored; and
concluding that at least one of the identified storage devices is failing.

15. A computer program stored on tangible storage media comprising executable instructions for performing a method of identifying a failing storage device from a plurality of storage devices in which at least one of the data objects stored on one of the storage devices is a protected object stored on at least one other storage device within the plurality of storage devices, and in which an inconsistency map is maintained of protected objects for which there is a mismatch between copies of the protected object stored on different storage devices, the method comprising:
identifying from the inconsistency map the storage devices on which mismatched protected objects are stored; and
concluding that at least one of the identified storage devices is failing.
